(19) United States
(12) Patent Application Publication
(10) Pub. No.: US 2014/0337069 A1
(43) Pub. Date: Nov. 13, 2014

(54) DERIVING BUSINESS TRANSACTIONS FROM WEB LOGS

(71) Applicant: Infosys Limited, (US)

(72) Inventor: Amit Gawande, Amravati (IN)

(73) Assignee: Infosys Limited, Bangalore (IN)

(21) Appl. No.: 13/890,214

(22) Filed: May 8, 2013

(51) Int. Cl. G06Q 10/06

(52) U.S. Cl. CPC G06Q 10/063
USPC 705/7.11

(57) ABSTRACT

Computer-implemented systems, methods, and computer-readable media for deriving probable business transactions from a log file, the log file including a plurality of entries corresponding to traffic on a web server, each entry including a plurality of fields, including: pre-processing the log file to remove one or more fields and one or more entries unrelated to probable business transactions; processing the entries in the log file to identify one or more transactions; and processing the one or more transactions to identify one or more probable business transactions.

### RELATED APPLICATION DATA

This application is related to Indian Patent Application No: 1758/CHE/2012, filed May 7, 2012, the contents of which are incorporated herein by reference.

### BACKGROUND

Web servers are computing devices that run software (e.g., Apache or Microsoft IIS) to allow client devices to access web pages via web browser software. As client devices access web pages hosted by a web server, the web server customarily logs the transactions into a log file (e.g., a tab delimited text file). Collecting and mining web log records have become increasingly important for targeted marketing, promotions, traffic analysis, and the like.

Current systems, for example the system described in U.S. Pat. No. 7,694,311, allow for a business team to define a task or transaction accomplished by a user traversing a sequence of universal resource locators (URLs) which correspond to a user's navigation. Such systems may then mine the records in a web server's log file to identify when a single user's navigation pattern corresponds to a defined task. However, such systems have many limitations. The task definitions are often provided by a business team, however the sequence of URLs that a business team may identify as being traversed to perform a task may be different than the actual URLs traversed on the server (e.g., the business team may not correctly understand the design of the web site, the web site may have been modified since the definition was created, etc.). Further, the task definitions provided might not indicate the actual user behavior which might be very different from the expected behavior (e.g., a user may refresh pages, go back pages, link directly to a middle of a task sequence, etc.). Improved systems and methods for identifying business transactions are desired.

### BRIEF DESCRIPTION OF THE DRAWINGS

FIG. 1 illustrates the architecture of a distributed application system including one or more web server, one or more application server, and one or more database server.

FIG. 2 illustrates exemplary fields that may be logged in a web log.

FIG. 3 illustrates an exemplary web log showing a sequence of records corresponding to page traversals by various users.

FIG. 4 illustrates an exemplary process flow for deriving business transactions from a web log.

FIG. 5 illustrates an exemplary process flow useful for pre-processing log file entries.

FIG. 6 illustrates exemplary HTTP response status codes which may be found in a web log.

FIG. 7 illustrates pertinent fields in an exemplary embodiment that may be useful for business transaction identification.

FIG. 8 illustrates an exemplary process flow useful for identifying and purging entries erroneously identified as being from a single user.

FIGS. 9 and 10 illustrate an exemplary process flow configured to identify and tag URL sequences from a user as transactions.

FIGS. 11 through 14 illustrate exemplary analyses of sequences of URLs according to the process flow of FIGS. 9 and 10.

FIG. 15 illustrates an exemplary process flow configured for deriving probable business relevant transactions from a set of identified transactions.

FIG. 16 illustrates an exemplary process flow configured to identify and merge sub-transactions that do not complete a business transaction.

FIG. 17 illustrates an exemplary process flow configured to identify and merge sub-transactions that do not initiate a business transaction from the beginning but complete the business transaction.

FIG. 18 shows an exemplary computing device useful for performing processes disclosed herein.

While systems and methods are described herein by way of examples and embodiments, systems and methods for deriving probable business transactions from web logs are not limited to the embodiments or drawings described. The drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

### DETAILED DESCRIPTION

Disclosed embodiments provide systems, computer-implemented methods, and computer-readable media for deriving probable business transactions from web logs. The embodiments are configured to derive business transactions as sequences of URLs traversed by a user interacting with a web application. Unlike conventional systems for mining web logs, embodiments do not require information about the web application's resources or association information. Rather, embodiments may be useful for deriving business transaction definitions directly from web logs of production systems without requiring any knowledge of what the transactions are or the design of web pages or web applications. Embodiments utilize algorithms to parse through web logs, identify sequences of URLs that can be tagged as business transactions, and identify from within the tagged transactions key business transactions.

The transaction definitions arrived at using the disclosed embodiments may be used to perform transaction level analysis. This analysis may be used further for designing performance tests for the future web applications. As the transaction definitions derived by embodiments are extracted from real user requests, they are likely to provide more relevant and production-like metrics that may be used during performance testing.

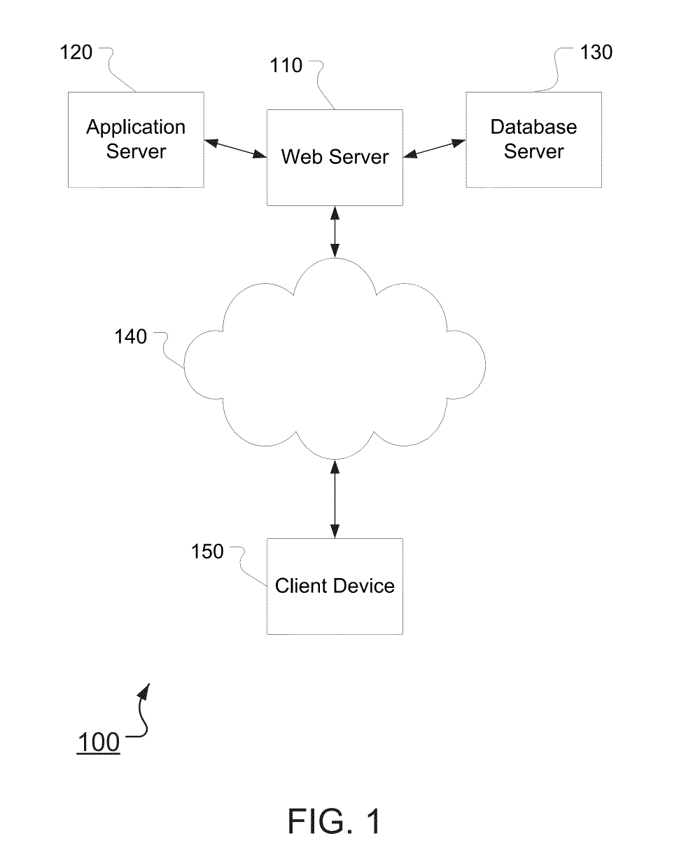

FIG. 1 illustrates the architecture of a distributed application system 100 including one or more web server 110, one or more application server 120, and one or more database server 130. Web server 110, application server 120, and database server 130 may be operatively coupled via one or more network 140, for example via one or more Local Area Network (LAN) or via the internet. Web server 110, application server 120, and database server 130 may be implemented with separate computing devices, may be implemented on a single computing device, or may be implemented in any other fashion. Web server 110 may act as the entry point for a web request originating from a client device 150. Each web request that passes via the web server 110 may be logged into a server log file as a log record (i.e., a log entry). Thus, web server 110 may generate records for all events that occur on the web server 110 and thus on the application server 120 that interacts with the web server 110. Each record provides basic information about a request made to a web application on the application server 120. The log file entries may provide insight into what load the servers might be under in the future. The entries may also help to understand how end users of client devices use the application.

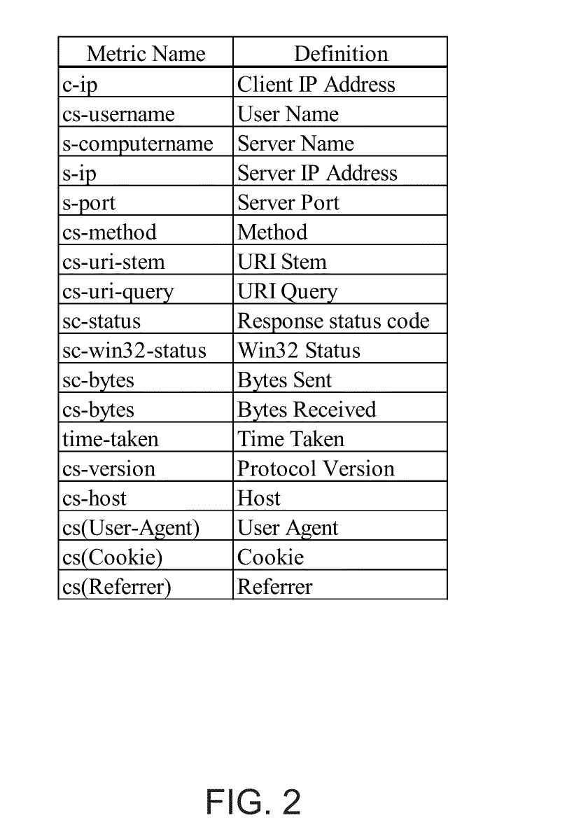

Web server logs may capture various information regarding web page requests. FIG. 2 illustrates exemplary fields that may be logged in a web log. The web server 110 may be configured to automatically log requested fields for events invoked by a client device 150. Of course, while some web logs may capture some or all of the fields shown in FIG. 2, alternative embodiments may use other web logs configured to log any number of fields corresponding to requests from client devices. For example, alternative embodiments may be configured to work with web server logs formatted according to the World Wide Web Consortium's (W3C) standard format (the Common Log Format) for web server logs. Still other embodiments may be configured to perform the processes described herein utilizing logs having proprietary formats. Of course, various steps may be modified or reordered for embodiments described herein to manipulate and analyze logs in alternative formats.

The embodiments disclosed herein may use the records stored in a web log to derive business transactions. A business transaction on a web application is a sequence of web pages traversed by a user to complete a unique business workflow. Thus, a business transaction may be defined in terms of the URLs of traversed pages. For example, a business transaction T1 may be defined as:
T1: URL_A->URL_B->URL_C->URL_D
   where URL_A, URL_B, URL_C, and URL_D are the URLs for pages A through D, respectively, of a web application that completes a business process.

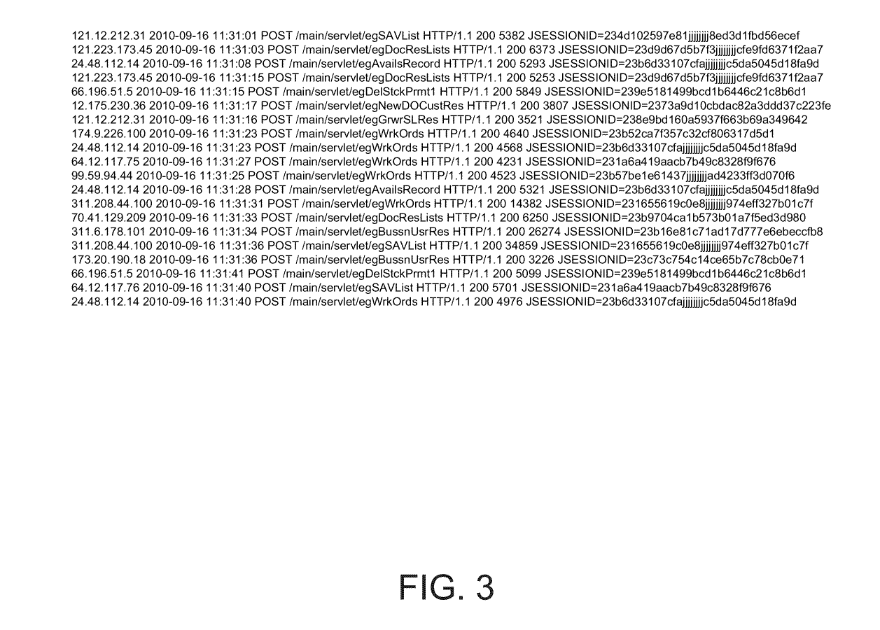

FIG. 3 illustrates an exemplary web log showing a sequence of records corresponding to page traversals by various users. In addition to page traversals, web logs include many records for support resources such as images, javascripts, stylesheet files, and the like that are not part of a business transaction. Embodiments may be configured to automatically parse through the log file and discover business transactions. Embodiments may accomplish this without receiving any business input relating to the operation of web applications or associations between URLs. In other words, embodiments may be configured to derive probable business transactions solely by analyzing records in one or more web logs.

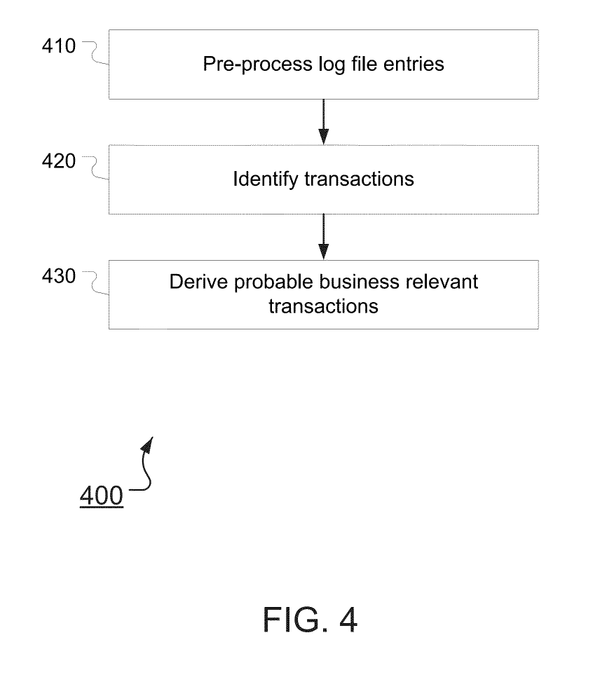

FIG. 4 illustrates an exemplary process flow 400 for deriving business transactions from a web log. Process flow 400 may be useful for automatically parsing through a web log file and discovering business transactions. In a first step 410, one or more computing devices may pre-process log file entries to identify and purge fields and entries that are not relevant to the business transaction identification process. In step 420, one or more computing devices may then identify one or more sets of sequences of URLs as business transactions. In step 430, one or more computing devices may then derive a set of probable business relevant transactions from the set of business transactions. Thus, process flow 400 allows for processing a web log to identify a set of probable business relevant transactions without requiring any business inputs for defining the transactions.

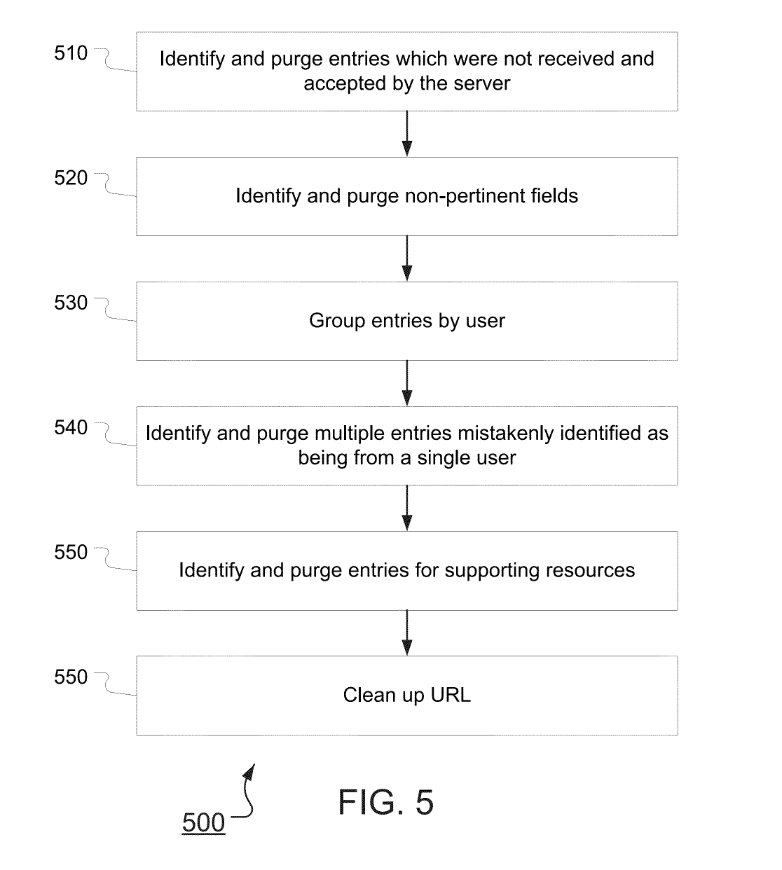

Referring now to step 410 of process flow 400 in greater detail, FIG. 5 illustrates an exemplary process flow 500 useful for pre-processing log file entries. Before analyzing the log files to identify transaction definitions, non-pertinent fields and entries may be purged to reduce the computing resources required to perform the overall business transaction identification process. Additionally, entries may be characterized based on user information so that entries from a single user session may be clustered together. This may enable transactions by a single user to be identified independent of simultaneous transactions by other users.

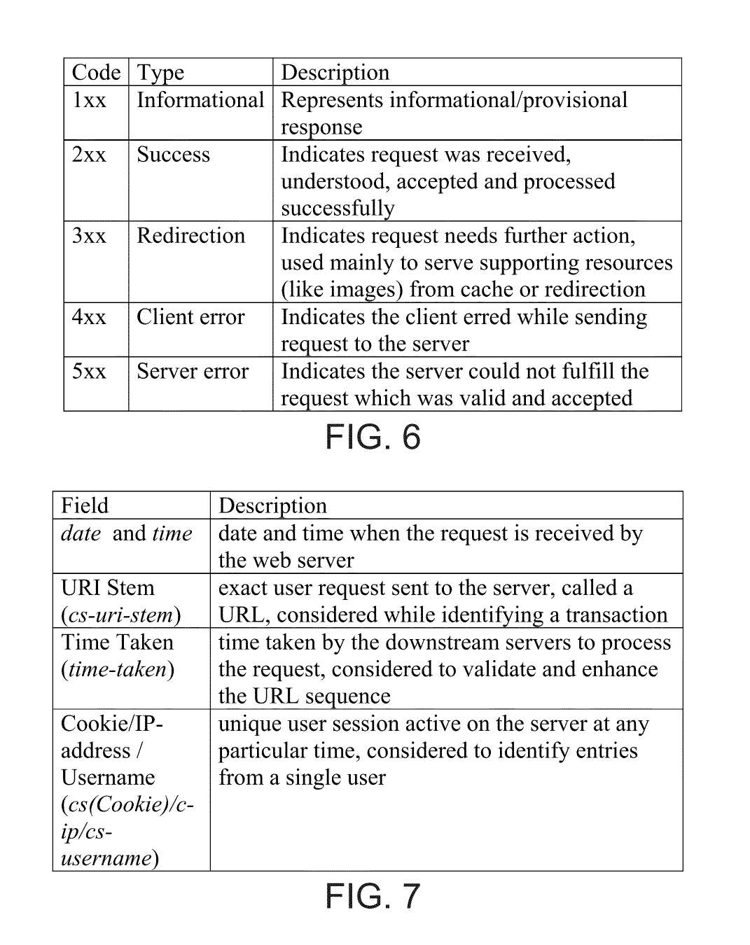

At step 510, one or more computing device may identify and purge entries which were not received and accepted by the web server. For example, a web log may include a HyperText Transfer Protocol (HTTP) response status code (typically represented as “sc-status”). An HTTP response status code may be a three digit code that defines what type of server response was sent back in reply to a request from a client device. FIG. 6 illustrates exemplary HTTP response status codes which may be found in a web log. Entries of type 2xx and 5xx may be considered as the only valid entries which were received and accepted by the web server. Thus, at step 510, all other entries in the web log may be identified as non-pertinent and purged.

At step 520, one or more computing device may identify and purge non-pertinent fields from the entries in the web log. The pertinent fields in a web log may be the date, time, Uniform Resource Identifier (URI) stem, time taken, and a user identifier fields. All other fields of the entries in the web log may be purged. FIG. 7 illustrates pertinent fields in an exemplary embodiment that may be useful for business transaction identification. The date and time fields may provide the date and time when the logged request was received by the web server. The cs-uri-stem field may provide the exact method or user request sent to the server (i.e., the URL). The time-taken may provide the time taken by the downstream servers (e.g., application servers, database servers, load balancers, etc.) to process the request. Any of the cs (Cookie), c-ip, and cs-username may be useful for identifying a unique user session active on the server at a particular time.

Once non-pertinent entries and fields are purged, in step 530 the entries in the log may be grouped by user. For example, entries from a single Internet Protocol (IP) address, corresponding to a unique cookie, or corresponding to a user name would be considered as entries from a single user session. If a log includes both an IP address and a cookie, the entries may be first sorted by IP address and then by cookie. IP address and cookie fields coupled together may then be combined to identify unique users.

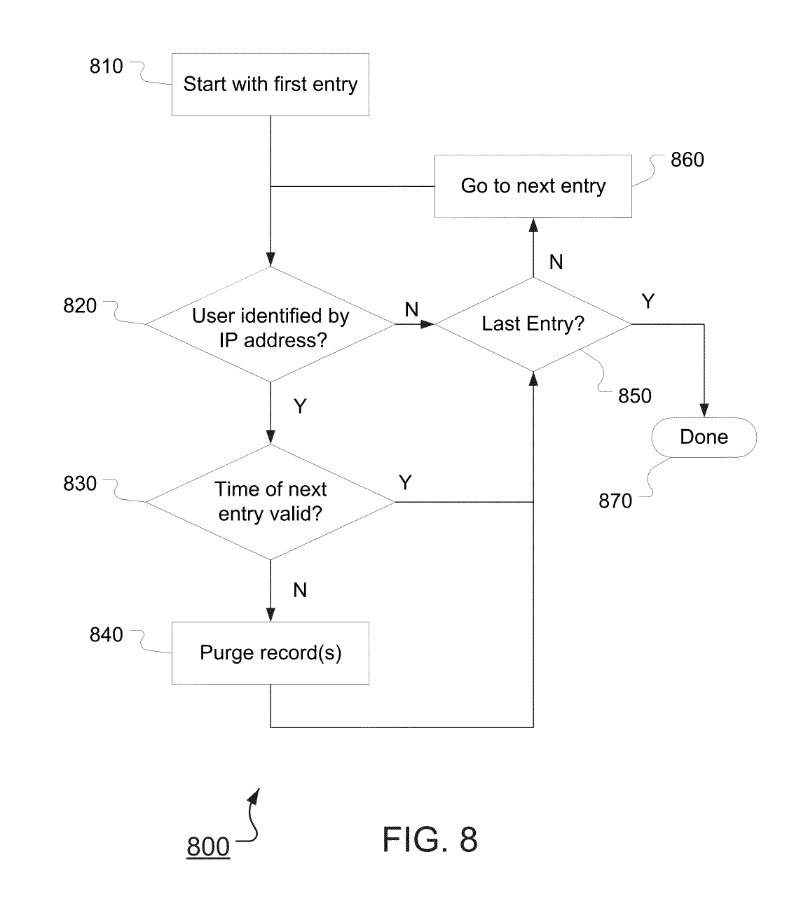

In step 540, one or more computing device may identify and purge multiple entries mistakenly identified as being from a single user. For example, multiple entries identified as being from a single user in step 530 because they are all associated with a single IP address may be erroneously identified if plural users' requests pass through a proxy server before reaching the web server. FIG. 8 illustrates an exemplary process flow 800 useful for identifying and purging entries erroneously identified as being from a single user. In step 810, a first entry may be analyzed. In step 820, the process may identify whether the entry is associated with a user based on a client device's IP address. If not, the process may proceed to step 850 to check if the entry being analyzed is the last entry. If so, the process may terminate at 870 because all entries have been checked. If not, the process may proceed to step 860 and then check whether the next entry is associated with a user based on a client device's IP address at step 820.

If at step 820 the process identifies that the entry is associated with a user based on a client device's IP address, the process may proceed to step 830 to determine whether the time of the next entry in the log is valid. Specifically, embodiments may check whether the date and time of the next entry is smaller than the sum of the date and time of the current entry and the time taken for the current entry. This test may be illustrated by the following equation:

(date and time of next entry)<((date and time of current entry)+(time taken for current entry))

This represents the scenario that occurs if before the web server responds back to a request associated with an IP address, another request is made from the same IP address. This scenario likely corresponds to requests from multiple computing devices using the same proxy. If the time of the next entry is not identified as valid in step 830, at step 840 one or more entries in the log associated with the IP address may be purged. In some embodiments, in step 840 all entries associated with the IP address may be purged. After purging the records, at step 850 the process may be terminated if all entries have been checked or may proceed to the next entry if entries remain in the log.

Referring again to process flow 500, at step 550 one or more computing device may identify and purge entries for supporting resources. For example, entries for resources such as images, stylesheets, javascripts, and the like may be purged. This may be performed by examining the file extensions of the version (cs-uri-stem) field in each entry and purging entries having extensions known to be associated with supporting resources (e.g., .jpeg, .css, .js, etc.).

Next, at step 550, one or more computing device may clean up the remaining URLs in the log by removing or masking the dynamic portion of the URLs. For example, a typical URL in a log may be:
scheme://domain:port/path?query_string#fragment_id
   where the ?query_string portion is used to pass data with the request to the server and usually contains a name-value pair (e.g., “?first_name=abc&last_name=xyz”). The value part (e.g., whatever follows the ‘=’ character) is often a dynamic portion which may change with each request or session. In this step, dynamic portions of the URLs may be identified and masked with the same value so that a changing value does not change the URL during transaction identification. Alternatively, dynamic portions of URLs may be identified and be removed altogether.

Upon completion of process flow 500, embodiments may provide a set of entries sorted and grouped by user session. Additionally, each entry may only include fields required for identification of business transactions and non-pertinent entries may have been purged. Of course, various steps of process flow 500 may be omitted, rearranged, or otherwise modified according to various system design needs.

Referring again to process flow 400, at step 420 one or more computing device may identify transactions in the log data. The pre-processed data may be further processed to identify probable transactions. This may be achieved by identifying specific and repeatable URL sequences which are likely to be pertinent business transactions. The pre-processed entries may be parsed into groups of entries identified to be from individual users. During this parsing, the number of separate users (or session groups) may be counted and stored (e.g., as a SessionCount). Each group of entries may be further processed to identify repeatable URL sequences. The entries may be pre-sorted by date and time from the pre-processing step. The entries may then be processed to identify repeatable URL sequences.

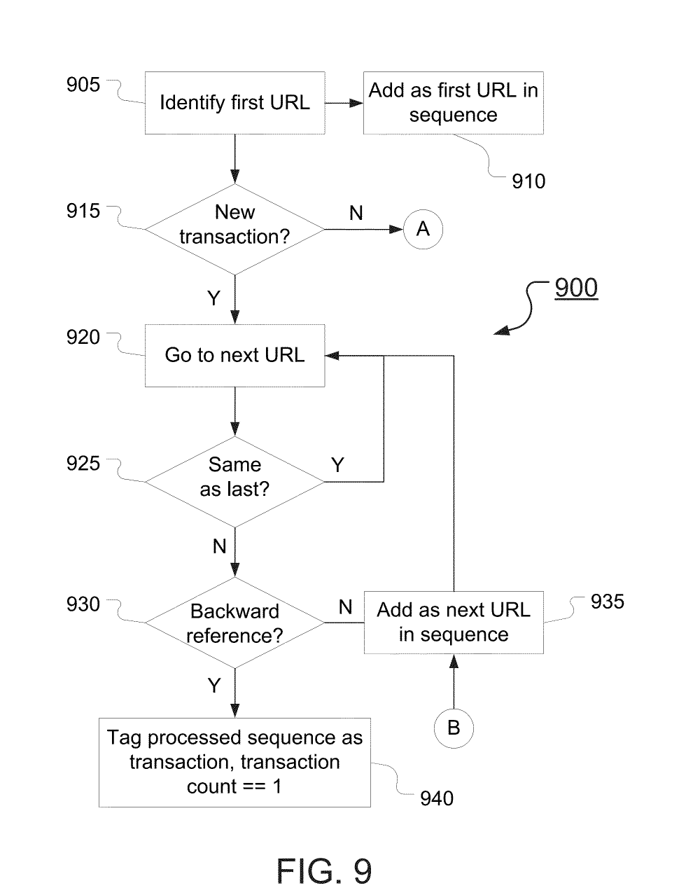

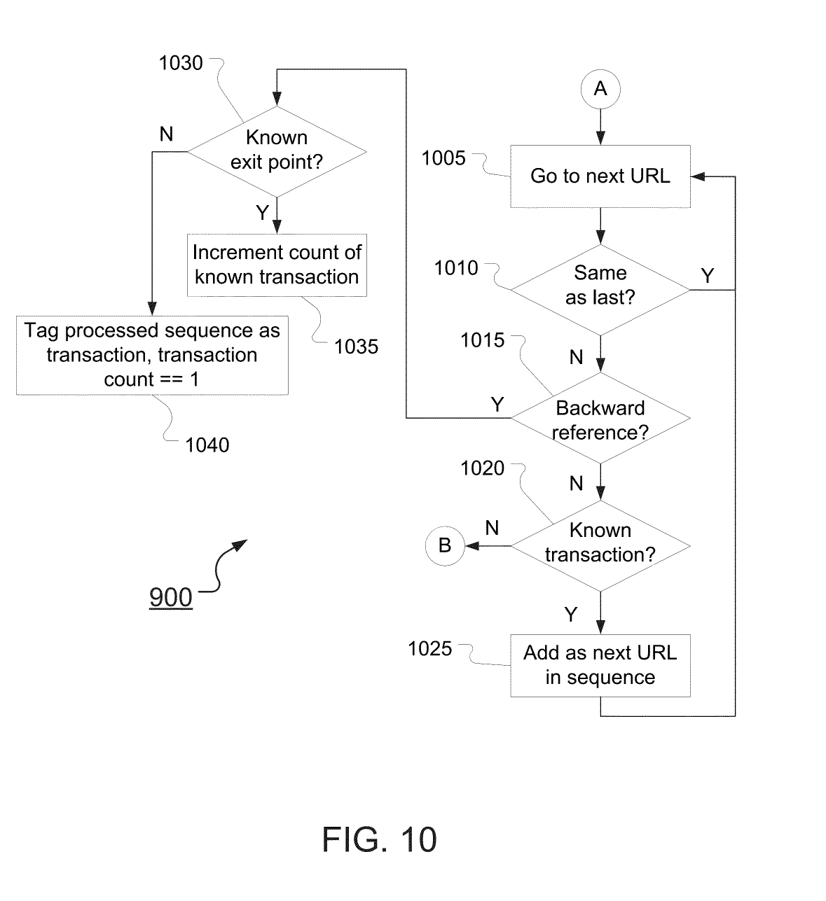

FIGS. 9 and 10 illustrate an exemplary process flow 900 configured to identify and tag URL sequences from a user as transactions. Process flow 900 illustrates a process to be performed individually for each identified user or user group. However, the tagged transactions may be visible across the entire user group so that a transaction tagged while processing one user's or group's entries may be referenced while processing entries from another user or group. Additionally, while process flow 900 illustrates a process to be performed for individual users or groups, one or more computing device may perform process flows 900 for plural users or groups simultaneously.

Process flow 900 may start at step 905 where a first URL is identified. The first URL may be added as a first URL in a sequence at step 910. At step 915, the process may determine whether the URL corresponds to a new transaction. If the URL corresponds to the first URL in an identified transaction sequence, the process flow may proceed to step 1005 shown in FIG. 10 (discussed in greater detail below). Alternatively, if the URL does not correspond to the first URL in an identified transaction sequence, the URL is identified as the first URL in a new transaction sequence and the process proceeds to step 920.

At step 920, the process proceeds to the next entry (i.e., the next URL) and at step 925 the process checks whether the next URL is the same as the previous URL. If the URL is the same, step 925 progresses to step 920 and the process proceeds to the next URL. When a different URL is reached, the process proceeds to step 930.

At step 930, the process determines whether the URL is a backward reference (i.e., is the same as a URL that has already been processed). For example, a backward reference may be a URL that belongs to any of the identified transactions. In other embodiments, a backward reference may be limited to a URL already in the current sequence. A backward reference identifies an end point of a new transaction. If a backward reference is identified in step 930, the process proceeds to step 940. At step 940 the processed sequence is tagged as a new transaction and the transaction count for the new transaction is set to 1. If the process determines that the URL is not a backward reference, the process adds the URL to the sequence at step 935 and proceeds to the next URL at step 920.

Referring now to FIG. 10, if process flow 900 identifies a URL as the start point of an already tagged transaction sequence, the process proceeds to determine whether the URL sequence being analyzed corresponds to an already tagged transaction sequence (i.e., the remainder of the URL sequence corresponds to a tagged transaction sequence) or whether the URL sequence being analyzed deviates from an already tagged transaction sequence. If the sequence is identified as the same as an already tagged sequence, the sequence count for that sequence may be incremented. Otherwise, the tagged sequence may be tagged as a new transaction.

At step 1005, the process flow may proceed to the next URL. Step 1010 may check whether the new URL is the same as the previous URL, and if so, may direct the process flow back to step 1005 until a new URL is reached. At step 1015, the process may check whether the URL is a backward reference. If so, at step 1030 the process may check whether the URL is a known exit point (i.e., whether the URL corresponds to the last URL of any already tagged transaction sequence). If so, the sequence being analyzed corresponds to an already identified transaction sequence, so at step 1035 the transaction count for the sequence may be incremented by 1. Alternatively, if the exit point does not correspond to the exit point of a known sequence, the URL sequence may be tagged as a new transaction sequence at step 1040 and the transaction count for the new transaction sequence may be initialized to 1.

Alternatively, if step 1015 identifies the URL as not being a backward reference, the process may continue to step 1020. At step 1020, the process checks whether the URL sequence continues to correspond to a known transaction sequence. If not, the process proceeds to step 935 and proceeds to follow the steps described above with reference to FIG. 9. Alternatively, if the URL sequence continues to correspond to a known transaction sequence, the URL is added as the next URL in the sequence at step 1025 and the process proceeds to the next URL at step 1005. Process flow 900 will continue analyzing URLs until a backward reference is reached and once a backward reference is reached, either the sequence will be tagged as a new transaction or the transaction count of a known transaction will be incremented. While not illustrated in FIGS. 9 and 10, after termination the process flow may start again at step 905 identifying the current URL (i.e., the backward reference) as a new “first” URL in a new sequence. For each tagged transaction sequence, a user count may be stored which corresponds to the number of unique users identified as carrying out the transaction.

FIGS. 11 through 14 illustrate exemplary analyses of sequences of URLs according to the process flow 900 of FIGS. 9 and 10. In each of these figures, each character represents a URL (e.g., the cs-uni-stem field) from a web log associated with a user session. The arrow represents the current reference URL. In the Example of FIG. 11, consider the URL sequence to be the first URL sequence to be analyzed. URL A is first considered and added as the first URL in a URL sequence T1. The process then proceeds to the next URL E. Because E is not the same as the last URL (i.e., E≠A), and E is not a backward reference (i.e., E∉T1), E is added as the next URL in the sequence (i.e., T1=AE) and the process proceeds to the next URL F. F is not the same as the last URL (i.e., F≠E) and F is not a backward reference (i.e., F∉T1), so F is added as the next URL in the sequence (i.e., T1=AEF). Next, the process proceeds to the next URL A. A is not the same as the last URL (i.e., A≠F), but A is a backward reference (i.e., A∈T1), therefore sequence T1 is tagged as a transaction and the transaction count for the sequence is set to 1.

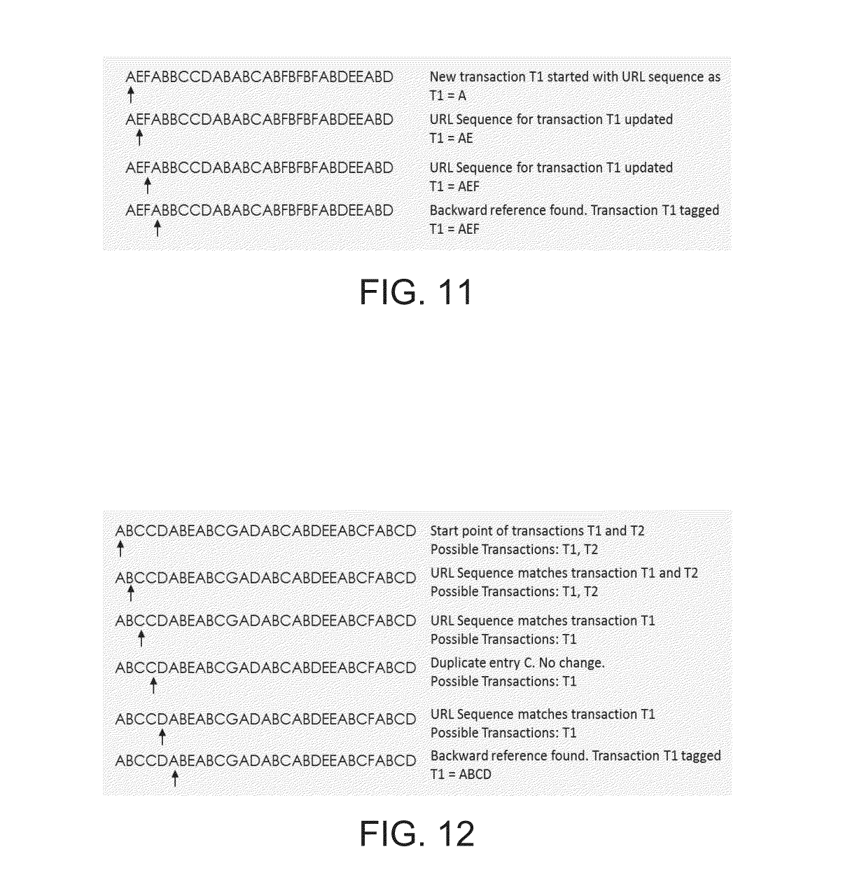

Referring now to the exemplary scenarios shown in FIGS. 12 through 14, these URLs sequences are analyzed after transactions T1=ABCD, T2=ABED, and T3=BEF were already tagged as transactions. Considering now FIG. 12, the first URL A is added as the first URL in a sequence. A process may identify A as a start point of both transactions T1 and T2. The process may then proceed to URL B. To clarify this illustration, not all steps (e.g., checking whether each URL is the same as the last URL and checking whether each URL is a backward reference) are fully described with reference to each URL being considered. B may be identified as the next URL of both transactions T1 and T2, so B may be added to the URL sequence and the process may proceed to the next URL. C may then be identified as the next URL of the transaction T1, so C may be added to the URL sequence and the process may proceed to the next URL. C may then be identified as the same as the last URL, so the process may proceed to the next URL without adding C to the sequence again. D may then be identified as the next URL of the transaction T1, so D may be added to the URL sequence and the process may proceed to the next URL. Finally A may be identified as a backward reference and D may be identified as the known endpoint of transaction T1, therefore the URL sequence may be identified as T1 and the transaction count for T1 may be incremented by one.

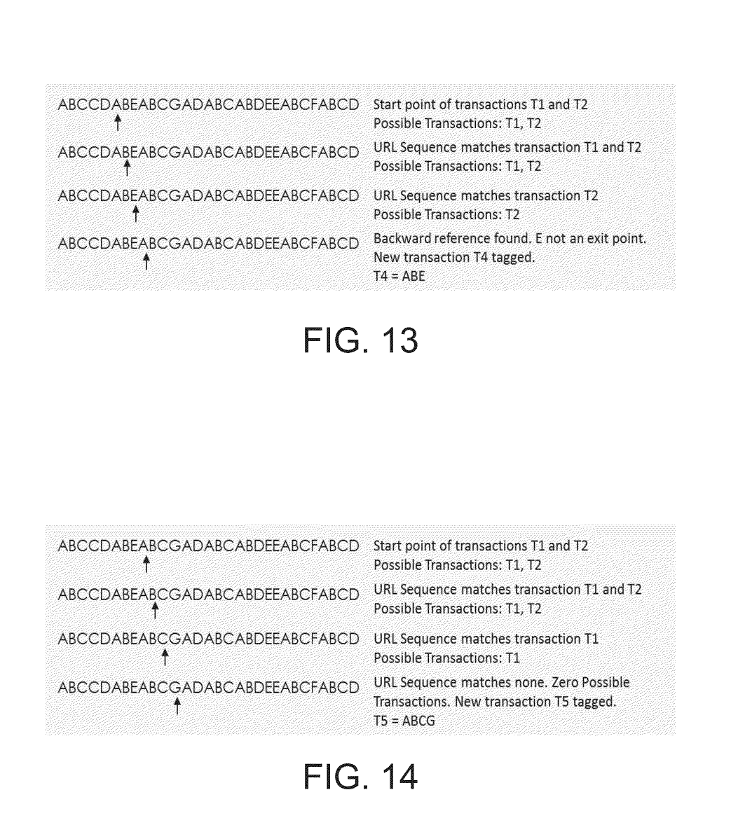

Referring now to FIG. 13 and continuing analyzing the same URL sequence, URL A may be added as the first URL in a new sequence and may be identified as a start point of both transactions T1 and T2 and the process may proceed to the next URL. Next, B may be identified as the next URL of both transactions T1 and T2, so B may be added to the URL sequence and the process may proceed to the next URL. E may then be identified as the next URL in the transaction T2, so E may be added to the URL sequence and the process may proceed to the next URL. Finally, A may be identified as a backward reference. In this case the last URL in the sequence, E, is not the exit point of transaction T2, so the sequence ABE may be tagged as a new transaction T4 and the transaction count for T4 may be set to one.

Referring now to FIG. 13 and continuing analyzing the same URL sequence, URL A may be added as the first URL in a new senesce, may be identified as the start point of transactions T1 and T2, and the process may proceed to the next URL. B then may be identified as the next URL of both transactions T1 and T2, so B may be added to the URL sequence and the process may proceed to the next URL. C may then be identified as the next URL of transaction T1, so C may be added to the URL sequence and the process may proceed to the next URL. G may then be identified as not matching a known transaction, therefore it is added as the next URL in the sequence and the process may proceed to the next URL. A may then be identified as a backward reference, so the sequence ABCG may be tagged as a new transaction T5 and the transaction count for T5 may be set to one.

Referring again to process flow 400, at the end of the identifying transactions step 420, a list of tagged transactions may be represented as:
TransactionList=<ent₁, ent₂, ent₃, . . . , entₙ>
   where each entry entᵢ in the list represents a tagged transaction (i.e., a URL sequence). Each entry may be a quadruple taking the form:
entᵢ={URLᵢ, arrivingTime, timeTakenᵢ, userCountᵢ}
   where URL is the actual request entry (i.e., the cs-version from the log), arrivingTime is the time the resource was requested by the client (i.e., time and date from the log), timeTaken is the time it took for the server to respond back (i.e., time-taken from the log), and userCount is the number of users who requested the URL. The count of the occurrences of each transaction may be represented as:
tCount=<Cnt₁, Cnt₂, Cnt₃, . . . >
   where Cntᵢ is the count of the occurrence of the transaction i∈TransactionList. The number of users or session groups may be represented by SessionCount.

Referring again to process flow 400, once transactions are identified at step 420, at step 430 the process may derive probable business relevant transactions from the identified transactions. This step may analyze the identified transactions based on an assumption that a URL sequence that is followed by a large number of users across the user base and possibly many times by individual users is more likely to be a transaction that corresponds to a business process.

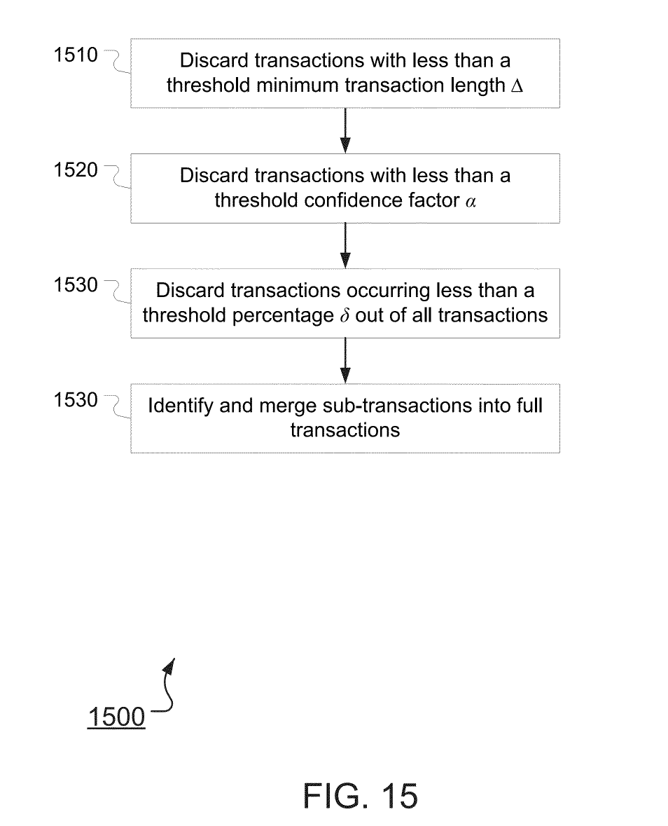

FIG. 15 illustrates an exemplary process flow 1500 configured for deriving probable business relevant transactions from a set of identified transactions. At step 1500, all transactions with a number of URLs in the sequence less than a minimum transaction length factor (Δ) may be discarded. The minimum transaction length factor may be user defined, for example by a business user, and may be defined on a case-by-case basis. The minimum transaction length factor may be selected to avoid considering transactions with undesirably short sequence lengths. This may avoid mistakenly identifying anomalously, but often-occurring, short sequences (e.g., two, three, or four URL sequences) as indicating significant business transactions.

At step 1520, transactions having a user count percentage less than a threshold confidence factor (α) may be discarded. The user count percentage may be calculated as the ratio of the userCountᵢ to the SessionCount (i.e., userCountᵢ/SessionCount). The threshold confidence factor may be user defined, for example by a business user, and may be defined on a case-by-case basis. The confidence factor may be selected to avoid considering transactions performed by an undesirably small percentage of users or user groups. This may avoid mistakenly identifying a common sequence performed often but only by comparatively few users as indicating significant business transactions.

At step 1530, transactions occurring less than a threshold percentage (δ) out of all transactions may be discarded. A user defined non-significance factor may be used to discard the URL sequences (i.e., transactions) which may not be carried out a sufficient percentage of the time to be considered as valid business processes. Tagged transactions may be sorted by their percentage of the total transactions (calculated as Cntᵢ/TotalEntryCount) and the bottom percentage of the transactions may be discarded. The non-significance factor may be user defined on a case-by-case basis.

At step 1530, sub-transactions may be identified and merged into full transactions. Sub-transactions may include URL sequences that follow the same path as an identified business process but do not complete the business process, URL sequences that complete the same path as an identified business process but do not initiate the business process from the beginning, or both. In this step, each transaction identified as a sub-transaction of another transaction may be discarded and the another transaction's transaction count may be incremented by the transaction count of the discarded sub-transaction.

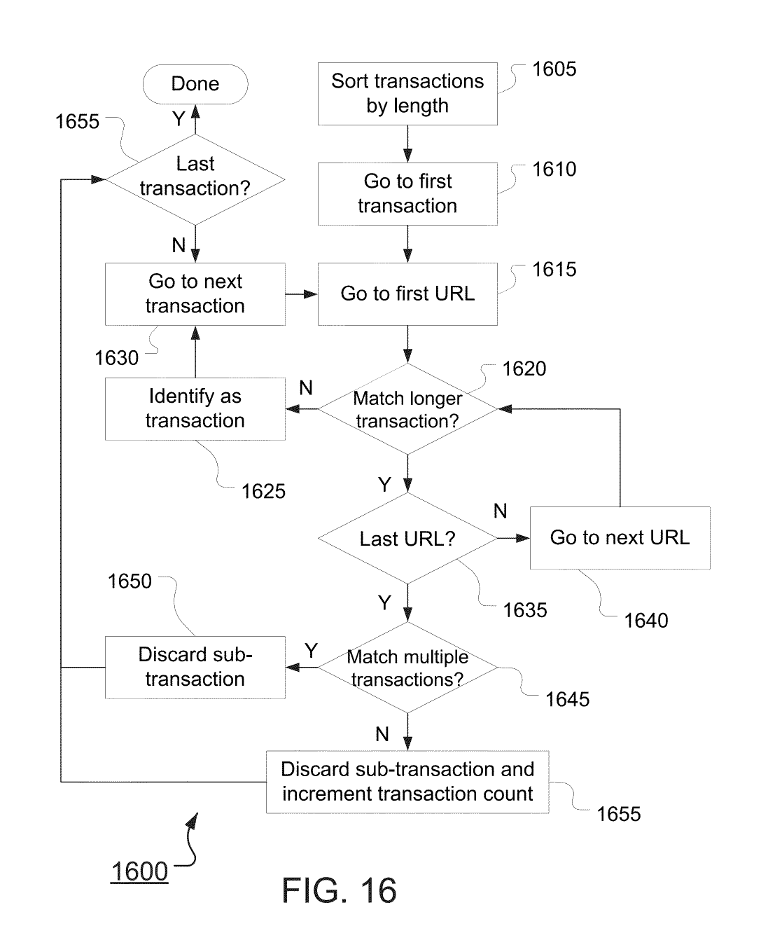

FIG. 16 illustrates an exemplary process flow 1600 configured to identify and merge sub-transactions that do not complete a business transaction. At step 1605, the process may sort the transactions by length (i.e., by number of URLs in the sequence). At step 1610, the process may proceed to the first transaction and at step 1615 it may proceed to the first URL in the transaction. At step 1620, the process may identify whether the sequence in the current transaction matches any other longer transactions. If not, the process flow identifies the current transaction as a transaction (i.e., the process does not identify the transaction as a sub-transaction) and proceeds to the next longest transaction in step 1630. Alternatively, if the URL sequence in the current transaction matches at least one longer transaction, at step 1635 the process will identify whether the current URL in the sequence is the last URL in the transaction. If not, at step 1640 the process proceeds to the next URL in the transaction. Otherwise, at step 1635 the process tests whether the transaction matches multiple longer transactions. If so, at step 1650 the current transaction is discarded. In this case the transaction may be discarded because the sub-transaction does not provide a significant indication of the business process that was being traversed by the user. Alternatively, if the current transaction only matches a single longer transaction, at step 1655 the current transaction may be discarded as a sub-transaction and the longer transaction that corresponds to the discarded sub-transaction may have its transaction count incremented by the transaction count of the sub-transaction. For example, if a transaction T1: ABCD had a transaction count of 4 and was identified as a sub-transaction of T7: ABCDEG having a transaction count of 2, transaction T1 may be discarded as a sub-transaction and transaction T7 may have its transaction count incremented to 6. The process may proceed until step 1655 identifies that all transactions have been analyzed.

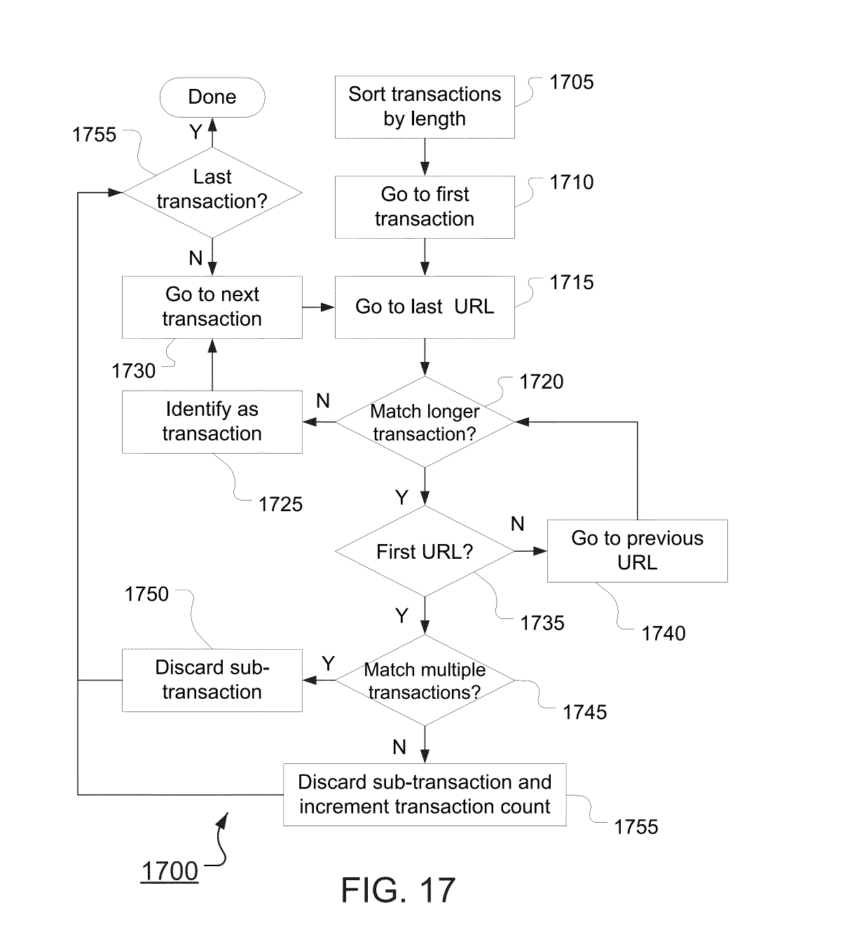

As described above with reference to step 1530 of process flow 1500, embodiments may also identify and merge sub-transactions that do not initiate a business transaction from the beginning but complete the business transaction. FIG. 17 illustrates an exemplary process flow 1700 configured to identify and merge such sub-transactions. Process flow 1700 generally performs similar steps to process flow 1600 described above, however the matching and parsing is done in reverse order (i.e., starting from the ending point of each URL sequence).

Process flow 1500 may result in the identification of probable business transactions. The transactions may be sorted and otherwise utilized by further downstream processing.

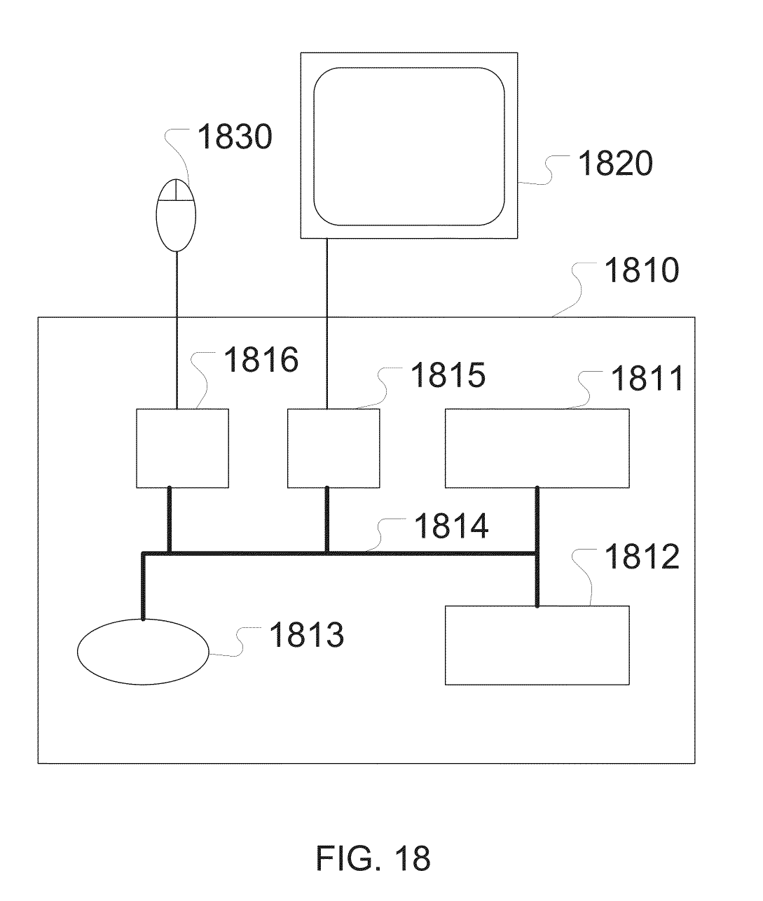

These embodiments may be implemented with software, for example modules configured to perform the steps of the process flows described herein when executed on computing devices such as computing device 1810 of FIG. 18. Of course, modules described herein illustrate various functionalities and do not limit the structure of any embodiments. Rather the functionality of various modules may be divided differently and performed by more or fewer modules according to various design considerations.

Computing device 1810 has one or more processing device 1811 designed to process instructions, for example computer readable instructions (i.e., code) stored on a storage device 1813. By processing instructions, processing device 1811 may perform the steps and functions disclosed herein. Storage device 1813 may be any type of storage device (e.g., an optical storage device, a magnetic storage device, a solid state storage device, etc.), for example a non-transitory storage device. Alternatively, instructions may be stored in one or more remote storage devices, for example storage devices accessed over a network or the internet. Computing device 1810 additionally may have memory 1812, an input controller 1816, and an output controller 1815. A bus 1814 may operatively couple components of computing device 1810, including processor 1811, memory 1812, storage device 1813, input controller 1816, output controller 1815, and any other devices (e.g., network controllers, sound controllers, etc.). Output controller 1815 may be operatively coupled (e.g., via a wired or wireless connection) to a display device 1820 (e.g., a monitor, television, mobile device screen, touch-display, etc.) in such a fashion that output controller 1815 can transform the display on display device 1820 (e.g., in response to modules executed). Input controller 1816 may be operatively coupled (e.g., via a wired or wireless connection) to input device 1830 (e.g., mouse, keyboard, touch-pad, scroll-ball, touch-display, etc.) in such a fashion that input can be received from a user.

Of course, FIG. 18 illustrates computing device 1810, display device 1820, and input device 1830 as separate devices for ease of identification only. Computing device 1810, display device 1820, and input device 1830 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 1810 may be one or more servers, for example a farm of networked servers, a clustered server environment, or a cloud network of computing devices.

Embodiments have been disclosed herein. However, various modifications can be made without departing from the scope of the embodiments as defined by the appended claims and legal equivalents.

What is claimed is:

1. A computer-implemented method executed by one or more computing devices for deriving probable business transactions from a log file, the log file including a plurality of entries corresponding to traffic on a web server, each entry including a plurality of fields, the method comprising:
pre-processing, by at least one of the one or more computing devices, the log file to remove one or more fields and one or more entries unrelated to probable business transactions;
processing, by at least one of the one or more computing devices, the entries in the log file to identify one or more transactions; and
processing, by at least one of the one or more computing devices, the one or more transactions to identify one or more probable business transactions.

2. The method of claim 1, where the step of pre-processing the log file to remove one or more fields and one or more entries unrelated to probable business transactions further comprises at least one of:
identifying and purging one or more entries in the log file that were not received and accepted by the web server;
identifying and purging one or more entries mistakenly identified as being from a single user;
identifying and purging one or more entries for supporting resources; and
masking a dynamic portion of one or more entries.

3. The method of claim 2, wherein one or more entries are flagged as mistakenly identified when a date_and_time of the chronologically next entry is less than the sum of a date_and_time of the current entry and a time_taken of the current entry.

4. The method of claim 1, wherein the step of processing the entries in the log file to identify one or more transactions further comprises:
identifying a sequence of uniform resource locators (URLs) traversed by a user;
parsing the sequence of URLs into a set of unique transactions; and
identifying a count of times each transaction is traversed.

5. The method of claim 4, further comprising:
identifying a second sequence of URLs traversed by a second user;
parsing the second sequence of URLs into a set of unique transactions; and
identifying the count of times each transaction is traversed,
wherein the count is a global variable providing a count of times each transaction is traversed independent of the user.

6. The method of claim 1, wherein the step of processing the one or more transactions to identify one or more probable business transactions further comprises at least one of:
discarding one or more transactions having less than a threshold minimum transaction length;
discarding one or more transactions having a user count percentage less than a threshold confidence factor;
discarding one or more transactions occurring less than a threshold percentage in comparison to all of the one or more transactions; and
identifying one or more sub-transactions and merging each sub-transaction into another transactions.

7. The method of claim of claim 1, wherein the step of processing the one or more transactions to identify one or more probable business transactions further comprises:
determining whether each of the one or more transactions is a sub-transaction of another transaction in the one or more transactions,
wherein a sub-transaction of another transaction is a transaction that satisfies at least one of the following:
the transaction starts as the same universal resource locator (URL) sequence as the another transaction and includes an identical partial URL sequence as the another transaction but ends before the another transaction, and
the transaction terminates at the same URL as the another transaction and ends with an identical partial URL sequence as the another transaction but does not start that the beginning URL of the another transaction; and
purging the sub-transaction and incrementing a transaction count of the another transaction if the transaction is identified as a sub-transaction of the another transaction.

8. A system for deriving probable business transactions from a log file, the log file including a plurality of entries corresponding to traffic on a web server, each entry including a plurality of fields, the system comprising:
a memory; and
a processor operatively coupled to the memory, the processor configured to perform the steps of:
pre-processing the log file to remove one or more fields and one or more entries unrelated to probable business transactions;
processing the entries in the log file to identify one or more transactions; and
processing the one or more transactions to identify one or more probable business transactions.

9. The system of claim 8, where the step of pre-processing the log file to remove one or more fields and one or more entries unrelated to probable business transactions further comprises at least one of:
identifying and purging one or more entries in the log file that were not received and accepted by the web server;
identifying and purging one or more entries mistakenly identified as being from a single user;
identifying and purging one or more entries for supporting resources; and
masking a dynamic portion of one or more entries.

10. The system of claim 9, wherein one or more entries are flagged as mistakenly identified when a date_and_time of the chronologically next entry is less than the sum of a date_and_time of the current entry and a time_taken of the current entry.

11. The system of claim 8, wherein the step of processing the entries in the log file to identify one or more transactions further comprises:
identifying a sequence of uniform resource locators (URLs) traversed by a user;
parsing the sequence of URLs into a set of unique transactions; and
identifying a count of times each transaction is traversed.

12. The system of claim 11, wherein the processor further performs the steps of:
identifying a second sequence of URLs traversed by a second user;
parsing the second sequence of URLs into a set of unique transactions; and
identifying the count of times each transaction is traversed,
wherein the count is a global variable providing a count of times each transaction is traversed independent of the user.

13. The system of claim 8, wherein the step of processing the one or more transactions to identify one or more probable business transactions further comprises at least one of:
discarding one or more transactions having less than a threshold minimum transaction length;
discarding one or more transactions having a user count percentage less than a threshold confidence factor;
discarding one or more transactions occurring less than a threshold percentage in comparison to all of the one or more transactions; and
identifying one or more sub-transactions and merging each sub-transaction into another transactions.

14. The system of claim of claim 8, wherein the step of processing the one or more transactions to identify one or more probable business transactions further comprises:
determining whether each of the one or more transactions is a sub-transaction of another transaction in the one or more transactions,
wherein a sub-transaction of another transaction is a transaction that satisfies at least one of the following:
the transaction starts as the same universal resource locator (URL) sequence as the another transaction and includes an identical partial URL sequence as the another transaction but ends before the another transaction, and
the transaction terminates at the same URL as the another transaction and ends with an identical partial URL sequence as the another transaction but does not start that the beginning URL of the another transaction; and
purging the sub-transaction and incrementing a transaction count of the another transaction if the transaction is identified as a sub-transaction of the another transaction.

15. A non-transitory computer-readable medium having computer-readable code stored thereon that, when executed by a computing device, performs a method for deriving probable business transactions from a log file, the log file including a plurality of entries corresponding to traffic on a web server, each entry including a plurality of fields, the method comprising:
pre-processing the log file to remove one or more fields and one or more entries unrelated to probable business transactions;
processing the entries in the log file to identify one or more transactions; and
processing the one or more transactions to identify one or more probable business transactions.

16. The medium of claim 15, where the step of pre-processing the log file to remove one or more fields and one or more entries unrelated to probable business transactions further comprises at least one of:
identifying and purging one or more entries in the log file that were not received and accepted by the web server;
identifying and purging one or more entries mistakenly identified as being from a single user;
identifying and purging one or more entries for supporting resources; and
masking a dynamic portion of one or more entries.

17. The medium of claim 16, wherein one or more entries are flagged as mistakenly identified when a date_and_time of the chronologically next entry is less than the sum of a date_and_time of the current entry and a time_taken of the current entry.

18. The medium of claim 15, wherein the step of processing the entries in the log file to identify one or more transactions further comprises:
identifying a sequence of uniform resource locators (URLs) traversed by a user;
parsing the sequence of URLs into a set of unique transactions; and
identifying a count of times each transaction is traversed.

19. The medium of claim 18, wherein the method further comprises:
identifying a second sequence of URLs traversed by a second user;
parsing the second sequence of URLs into a set of unique transactions; and
identifying the count of times each transaction is traversed,
wherein the count is a global variable providing a count of times each transaction is traversed independent of the user.

20. The method of claim 15, wherein the step of processing the one or more transactions to identify one or more probable business transactions further comprises at least one of:
discarding one or more transactions having less than a threshold minimum transaction length;
discarding one or more transactions having a user count percentage less than a threshold confidence factor;
discarding one or more transactions occurring less than a threshold percentage in comparison to all of the one or more transactions; and
identifying one or more sub-transactions and merging each sub-transaction into another transactions.
